(19) United States
(12) Patent Application Publication
(10) Pub. No.: US 2014/0052606 A1
(43) Pub. Date: Feb. 20, 2014

(54) SYSTEM AND METHOD FOR FACILITATING PREDICTION OF A LOAN RECOVERY DECISION

(71) Applicant: Infosys Limited, Bangalore (IN)

(72) Inventors: Bintu G. Vasudevan, Bangalore (IN); Anju G. Parvathy, Cochin (IN); Abhishek Kumar, Ranchi (IN); Rajesh Balakrishnan, Bangalore (IN)

(21) Appl. No.: 13/968,277

(22) Filed: Aug. 15, 2013

(30) Foreign Application Priority Data
Aug. 16, 2012 (IN) 3378/CHE/2012

(51) Int. Cl. G06Q 40/02

(52) U.S. Cl. CPC G06Q 40/025
USPC 705/38

(57) ABSTRACT

A system for facilitating prediction of a loan recovery decision pertaining to a customer of a financial institution is provided. The system comprises one or more databases comprising customer interaction data, customer profile data, and economic data. The system further comprises a Behavioral History Sequence (BHS) module configured to generate behavioral history sequence data associated with the customer. The BHS module generates the BHS data by sanitizing the customer interaction data and classifying the sanitized customer interaction data into predefined categories. The system further comprises a prediction module that is configured to predict payment behavior of the customer based on the BHS data, the customer profile data, and the economic data. The prediction module is further configured to predict the loan recovery decision pertaining to the customer, wherein the predicted loan recovery decision is based on the predicted payment behavior of the customer.

### FIELD

The present invention relates generally to loan recoveries. More particularly, the present invention provides a system and a method for predicting a loan recovery decision pertaining to a customer of a financial institution.

### BACKGROUND

In recent years, lending money has become a core business area for financial institutions like banks, credit unions, mortgage companies, and others. These financial institutions rely heavily on the repayment of the loans, with interest, for a significant portion of their revenue and profits. However, there are several instances when customers who have taken loan from the financial institution do not repay their loan amount or installments in time and therefore, the financial institutions incur losses in their revenues and profits. The financial institutions have systems in place to flag such customers as delinquent customers. For every delinquent customer, the financial institution then faces a decision regarding recovering the loan amount from the delinquent customer. Such a determination is generally made on the basis of discussions among the senior management or other officials with the aid of internal policies regarding actions to be taken for a particular type of delinquent customer. Often, these decisions are based on a relatively subjective understanding of only limited circumstances of the delinquent customer and not all the circumstances are taken into consideration and therefore, have limitations. Further, with a large customer base and as some delinquent customers are constantly on the move analyzing each delinquent customer manually becomes even more difficult for the financial institution.

Further, not all delinquent customers intend to fraud. Thus, it becomes important for a financial institution to understand or predict which of the delinquent customers are likely to repay their loan amount or at least some of the loan installments and accordingly determine a decision against the delinquent customer. Generally, every financial institution has its associated call center to interact with their customers. The executives at the call center make collection calls to the delinquent customers with a goal to stimulate the customer to pay all or part of the loan money. These interactions between the executives and the delinquent customers may facilitate prediction of the payment behavior of the delinquent customers and thus the associated loan recovery decision.

Also, it is important for the financial institution to forecast the change in the payment behavior of the delinquent customers due to change in the ability of the delinquent customers to repay the loan amount.

In light of the above, there is a need for a system and a method to predict the payment behaviors of the delinquent customer. The system and method should also be able to predict a loan recovery decision pertaining to the delinquent customer based on his payment behavior.

### SUMMARY

In an embodiment of the present invention, a system for facilitating prediction of a loan recovery decision pertaining to a customer of a financial institution is provided. The system comprises one or more databases that comprise customer interaction data, customer profile data, and economic data. The customer interaction data is unstructured data and comprises at least one of: call center notes, text messages from the customer, chats with the customer, emails from the customer, blogs written by the customer, call transcripts associated with the customer, feedback forms filled by the customer, and surveys filled by the customer. The customer profile data is structured data and comprises name of the customer, age of the customer, gender of the customer, employment details of the customer, bank account details of the customer, contact details of the customer, details of medical condition of the customer, details of natural calamities associated with the customer, credit score of the customer, and details of delinquencies by the customer in repaying the loan in last one year. The economic data is structured data and comprises Gross Domestic Product (GDP) data, inflation data, and interest rates of the financial institution.

The system further comprises a Behavioral History Sequence (BHS) module configured to generate behavioral history sequence data associated with the customer. The BHS module further comprises a text sanitization engine and a categorizer module. The text sanitization module is configured to filter out unwanted text from the customer interaction data and correct spellings in the customer interaction data. In an embodiment of the present invention, the text sanitization engine uses a Domain Specific Acronym (DSA) list, a Domain Dictionary (DD), and an English language dictionary to correct the spellings in the customer interaction data. The categorizer module is configured to classify the sanitized customer interaction data into predefined categories to generate the BHS data associated with the customer. The pre-defined categories correspond to payment behavioral states of the customer. The payment behavioral states of the customer comprise at least one of: ‘Promise to Pay’, ‘Negotiation Fail’, and ‘Not Available’. In an embodiment of the present invention, the categorizer module uses naive Bayes classification algorithm to classify the customer interaction data. The BHS module further comprises a staging database that stores the generated BHS data with domain specific rules and heuristics.

The system further comprises a prediction module configured to predict payment behavior of the customer based on the BHS data, the customer profile data, and the economic data. The prediction module is further configured to predict the loan recovery decision pertaining to the customer on the basis of the predicted payment behavior of the customer. The prediction module employs a Bayesian network with a plurality of nodes to predict the payment behavior of the customer and the associated loan recovery decision. Each node of the plurality of the nodes is associated with two or more states. Further, the payment behavior of the customer and the associated loan recovery decision is based on one of: state of each node of the plurality of the nodes and predicted next state of at least one node of the plurality of the nodes. In order to predict the next state of the at least one node of the plurality of the nodes, the prediction module employs a neural network. In an embodiment of the present invention, the customer may be a delinquent customer of the financial institution and the predicted payment behavior of the customer may be one of: Likely to Pay, Negotiable and Defaulter. The prediction module further facilitates performing root cause analysis, sensitivity analysis, and variability analysis of the predicted payment behavior of the customer. In embodiments of the present invention, the predicted loan recovery decision pertaining to the customer may be one of: a strict follow-up with the customer and a lenient follow-up with the customer.

In another embodiment of the present invention, a method for facilitating prediction of a loan recovery decision pertaining to a customer of a financial institution is provided. The method comprises sanitizing customer interaction data obtained from one or more databases. The customer interaction data is unstructured data and comprises at least one of: call center notes, text messages from the customer, chats with the customer, emails from the customer, blogs written by the customer, call transcripts associated with the customer, feedback forms filled by the customer, and surveys filled by the customer. Further, the sanitization comprises filtering out unwanted text from the customer interaction data and correcting spellings in the customer interaction data.

The method further comprises classifying the sanitized customer interaction data into predefined categories to generate BHS data associated with the customer. The pre-defined categories correspond to payment behavioral states of the customer. The payment behavioral states of the customer comprise at least one of: ‘Promise to Pay’, ‘Negotiation Fail’, and ‘Not Available’.

The method further comprises predicting payment behavior of the customer based on the BHS data, customer profile data, and economic data. The customer profile data and the economic data are obtained from the one or more databases. The customer profile data is structured data and comprises name of the customer, age of the customer, gender of the customer, employment details of the customer, bank account details of the customer, contact details of the customer, details of medical condition of the customer, details of natural calamities associated with the customer, credit score of the customer, and details of delinquencies by the customer in repaying the loan in last one year. The economic data is structured data and comprises GDP data, inflation data, and interest rates of the financial institution. Further, the prediction of the payment behavior of the customer and the loan recovery decision pertaining to the customer is done by employing a Bayesian network with a plurality of nodes. Each node of the plurality of the nodes is associated with two or more states. Further, the payment behavior of the customer and the associated loan recovery decision is based on one of: state of each node of the plurality of the nodes and predicted next state of at least one node of the plurality of the nodes. The prediction of the next state of the at least one node of the plurality of the nodes is done by a neural network. In an embodiment of the present invention, the customer may be a delinquent customer of the financial institution and the predicted payment behavior of the customer may be one of: Likely to Pay, Negotiable and Defaulter. The method further performs root cause analysis, sensitivity analysis, and variability analysis of the predicted payment behavior of the customer.

The method further comprises predicting the loan recovery decision pertaining to the customer. The predicted loan recovery decision is based on the predicted payment behavior of the customer and in embodiments of the present invention, may be one of: a strict follow-up with the customer and a lenient follow-up with the customer.

In yet another embodiment of the present invention, a computer program product for facilitating prediction of a loan recovery decision pertaining to a customer of a financial institution is provided. The computer program product comprises a non-transitory computer-readable medium having computer-readable program code stored thereon. Further, the computer-readable program code comprises instructions that when executed by a processor, cause the processor to sanitize the customer interaction data obtained from one or more databases. The customer interaction data is unstructured data and comprises at least one of: call center notes, text messages from the customer, chats with the customer, emails from the customer, blogs written by the customer, call transcripts associated with the customer, feedback forms filled by the customer, and surveys filled by the customer. Further, the sanitization comprises filtering out unwanted text from the customer interaction data and correcting spellings in the customer interaction data.

The processor further classifies the sanitized customer interaction data into predefined categories to generate BHS data associated with the customer. The pre-defined categories correspond to payment behavioral states of the customer. The payment behavioral states of the customer comprise at least one of: ‘Promise to Pay’, ‘Negotiation Fail’, and ‘Not Available’.

The processor further predicts payment behavior of the customer based on the BHS data, customer profile data, and economic data. The customer profile data and the economic data are obtained from the one or more databases. The customer profile data is structured data and comprises name of the customer, age of the customer, gender of the customer, employment details of the customer, bank account details of the customer, contact details of the customer, details of medical condition of the customer, details of natural calamities associated with the customer, credit score of the customer, and details of delinquencies by the customer in repaying the loan in last one year. The economic data is structured data and comprises GDP data, inflation data, and interest rates of the financial institution. Further, the prediction of the payment behavior of the customer and the loan recovery decision pertaining to the customer is done by employing a Bayesian network with a plurality of nodes. Each node of the plurality of the nodes is associated with two or more states. Further, the payment behavior of the customer and the associated loan recovery decision is based on one of: state of each node of the plurality of the nodes and predicted next state of at least one node of the plurality of the nodes. The prediction of the next state of the at least one node of the plurality of the nodes is done by a neural network. In an embodiment of the present invention, the customer may be a delinquent customer of the financial institution and the predicted payment behavior of the customer may be one of: Likely to Pay, Negotiable and Defaulter. The processor is further configured to perform root cause analysis, sensitivity analysis, and variability analysis of the predicted payment behavior of the customer.

The processor further predicts the loan recovery decision pertaining to the customer. The predicted loan recovery decision is based on the predicted payment behavior of the customer and in embodiments of the present invention, may be one of: a strict follow-up with the customer and a lenient follow-up with the customer.

### BRIEF DESCRIPTION OF THE ACCOMPANYING DRAWINGS

The present invention is described by way of embodiments illustrated in the accompanying drawings wherein:

FIG. 1 is a block diagram illustrating a system for facilitating prediction of a loan recovery decision pertaining to a customer of a financial institution in accordance with an embodiment of the present invention;

FIG. 2 is a block diagram illustrating architecture of a Behavioral History Sequence module in accordance with an embodiment of the present invention;

FIG. 3 is a block diagram of a system for predicting payment behavior of a customer and an associated loan recovery decision pertaining to the customer in accordance with an embodiment of the present invention;

FIGS. 4A and 4B illustrate exemplary Bayesian networks to predict payment behavior of a customer in accordance with an embodiment of the present invention;

FIGS. 5A and 5B illustrate exemplary Bayesian networks to predict a loan recovery decision pertaining to a customer in accordance with an embodiment of the present invention;

FIG. 6 is a flowchart depicting a method for facilitating prediction of a loan recovery decision pertaining to a customer in accordance with an embodiment of the present invention.

### DETAILED DESCRIPTION OF THE INVENTION

A system, a method and a computer program product for facilitating prediction of a loan recovery decision pertaining to a customer of a financial institution is described herein. The invention provides a system, a method and a computer program product for predicting payment behavior of the customer based on the interactions between the customer and the financial institution, customer's profile data, and economic data. The invention further provides a system, a method and a computer program product for predicting the loan recovery decision pertaining to the customer based on the predicted payment behavior of the customer. The method of the invention may be provided on a computer readable medium.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

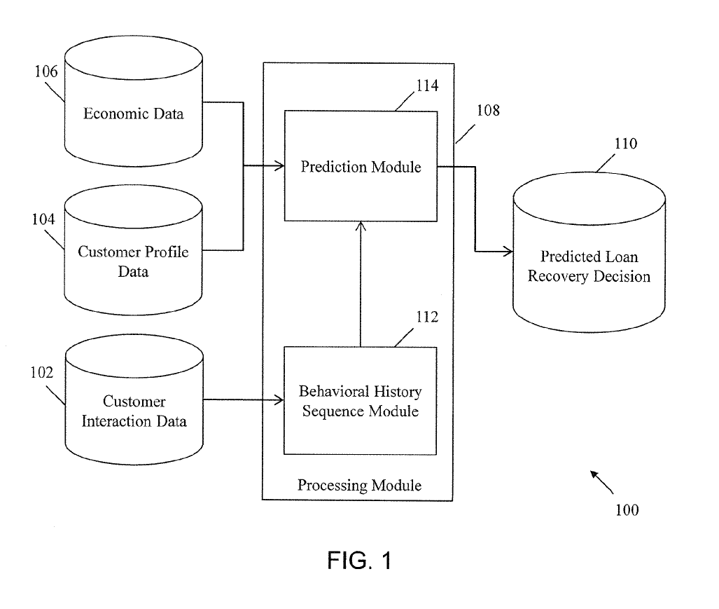

FIG. 1 is a block diagram illustrating a system 100 for facilitating prediction of a loan recovery decision pertaining to a customer of a financial institution in accordance with an embodiment of the present invention. The financial institution may be, without any limitation, a commercial bank, a credit union, a stock brokerage firm, an asset management firm, an insurance company, a finance company, a building society, a retailer, and a lending institution. In an embodiment of the present invention, the customer may be a loan customer of the financial institution and may be a delinquent one who fails to repay the loan or loan installments in time to the financial institution. Further, the system 100 may include one or more databases comprising customer interaction data, customer profile data and economic data. In an embodiment of the present invention, the system 100 may include a first database 102 comprising customer interaction data, a second database 104 comprising customer profile data and a third database 106 comprising economic data. The system 100 may also include a processing module 108, and a fourth database 110 comprising output of the processing module 108 which is the predicted loan recovery decision pertaining to the customer. The processing module 108 may further include a Behavioral History Sequence (BHS) module 112 and a prediction module 114. In an embodiment of the present invention, the system 100 as described in the present invention or any of its modules may be embodied in the form of a computer system. Typical examples of a computer system may include a general-purpose computer, a programmed microprocessor, a micro-controller, a peripheral integrated circuit element, and other devices or arrangements of devices.

The computer system may comprise a central processing module, an input device, and a display unit. Further, the computer system may be communicatively coupled to other similar computer systems via a communication network like Internet. The computer system may also include a non-transitory computer readable medium which may comprise a Random Access Memory (RAM), a Read only Memory (ROM); a mass storage typically for more permanent storage, such as optical discs, forms of magnetic storage like hard disks, tapes, drums, cards and other types, processor registers, cache memory, volatile memory, non-volatile memory; an optical storage such as a Compact Disc (CD), a Digital Video Disc (DVD), and the like. Further, the non-transitory computer readable medium stores methods, programs, codes, and program instructions. The central processing module may comprise a processor, which is communicatively coupled to the non-transitory computer readable medium and a communication bus. The processor may be part of, without any limitation, a server, a client, a network infrastructure, a mobile computing platform, and a stationary computing platform. The processor may be any kind of computational or processing device capable of executing program instructions, codes, binary instructions and the like. The processor may be or include, without any limitation, a signal processor, a digital processor, an embedded processor, a microprocessor, and a co-processor that may directly or indirectly facilitate execution of program code or program instructions stored thereon. The processor may include memory that stores methods, codes, instructions and programs as described herein and elsewhere. The processor may access the non-transitory computer readable medium through an interface.

Further, in an embodiment of the present invention, the first database 102, the second database 104, the third database 106, the processing module 108, and the fourth database 110 may reside on a single computer system. In another embodiment of the present invention, the first database 102, the second database 104, the third database 106, the processing module 108, and the fourth database 110 may reside on different computer systems and may be communicatively coupled to each other via the communication network. In various embodiments of the present invention, the communication network may be, without any limitation, a Local Area Network (LAN), a Metropolitan Area Network (MAN), a Wide Area Network (WAN) like Internet, and a private network.

In an embodiment of the present invention, the system 100 may be hosted by the financial institution to predict the loan recovery decisions pertaining to its delinquent customers. In another embodiment of the present invention, the system 100 may be hosted by a third party and may be accessed by a plurality of financial institutions over a cloud network.

Further, in an embodiment of the present invention, the processing module 108, the BHS module 112, the prediction module 114 and the other modules described hereinafter transform different types of data including, without any limitation, the data stored in the first database 102, the second database 104, the third database 106, the fourth database 110, and any other database described hereinafter from one state of the data to another state of the data.

In an embodiment of the present invention, the customer interaction data stored in the first database 102 is the data captured during interactions between the financial institution and the customer. In embodiments of the present invention, the interaction between the financial institution and the customer may occur through various ways including, without any limitation, voice calls, data calls, emails, chats, blogs, and surveys. Further, in embodiments of the present invention, the first database 102 may be hardware or software or hardware with embedded software or a firmware for storing the customer interaction data. The first database 102 may be a memory or a storage device operable to store the customer interaction data. For example, the first database 102 may be a RAM, a ROM, an optical storage device, a magnetic media, etc., either integrated with the system 100 or configured as a separate device. The customer interaction data may be stored in the first database 102 in a relational manner, in a flat file manner or any other known manner in the art.

Further the customer interaction data may include notes taken by executives of a call center (associated with the financial institution) while interacting with the customer, text messages from the customer, chats with the customer, emails from the customer, blogs written by the customer, call transcripts associated with the customer, feedback forms filled by the customer, surveys filled by the customer, and the like. In an embodiment of the present invention, the customer interaction data may be unstructured data and may include usage of finance related abbreviations and acronyms, and misspelled words. It may be apparent to a person of ordinary skill in the art that the customer interaction data being unstructured in nature possesses all known in the art characteristics of the unstructured data. Further, the customer interaction data may be stored in the first database 102 with a timestamp against a customer's unique identification code. The customer's unique identification code may be a code assigned to each customer of the financial institution and may be, without any limitation, a numeric code, an alphanumeric code or any other type of code. Further, the customer interaction data collected at the call center of the financial institution may be stored sequentially in the first database 102 and may be aggregated on a monthly basis for the customer. In an embodiment of the present invention, the first database 102 may comprise customer interaction data associated with all the delinquent customers of the financial institution. In another embodiment of the present invention, the first database 102 may comprise customer interaction data associated with all the customers of the financial institution.

The customer profile data stored in the second database 104 may comprise, without any limitation, name of the customer, age of the customer, gender of the customer, employment details of the customer, bank account details of the customer, contact details of the customer, details of medical condition of the customer, credit scores of the customer, details of delinquencies by the customer in repaying the loan in last one year, and details of natural calamities associated with the customer that may influence payment behavior of the customer. The examples of natural calamities may include, without any limitation, earthquakes, landslides, tornados, cyclones, floods, and volcanic eruptions. In an embodiment of the present invention, the second database 104 may comprise customer profile data associated with all the delinquent customers of the financial institution. In another embodiment of the present invention, the second database 104 may comprise customer profile data associated with all the customers of the financial institution. In an embodiment of the present invention, the customer profile data may be structured data. It may be apparent to a person of ordinary skill in the art that the customer profile data being structured in nature may possess all known in the art characteristics of the structured data. Further, the second database 104 may be in communication with third party databases to update the customer profile data. In various embodiments of the present invention, the second database 104 may be hardware or software or hardware with embedded software or a firmware for storing the customer profile data. The second database 104 may be a memory or a storage device operable to store the customer profile data. For example, the second database 104 may be a RAM, a ROM, an optical storage device, a magnetic media, etc., either integrated with the system 100 or configured as a separate device. The customer profile data may be stored in the second database 104 in a relational manner, in a flat file manner or any other known manner in the art.

The economic data stored in the third database 106 may comprise, without any limitation Gross Domestic Product (GDP) data, inflation data, and interest rates of the financial institution. In an embodiment of the present invention, the economic data may be structured data. It may be apparent to a person of ordinary skill in the art that the economic data being structured in nature may possess all known in the art characteristics of the structured data. The third database 106 may be in communication with third party databases to update the economic data. Further in embodiments of the present invention, the third database 106 may be hardware or software or hardware with embedded software or a firmware for storing the economic data. The third database 106 may be memory or a storage device operable to store the economic data. For example, the third database 106 may be a RAM, a ROM, an optical storage device, a magnetic media, etc., either integrated with the system 100 or configured as a separate device. The economic data may be stored in the third database 106 in a relational manner, in a flat file manner or any other known manner in the art.

The BHS module 112, in various embodiments of the present invention, may be hardware or software or hardware with embedded software or a firmware that is configured to generate BHS data associated with the customer. In an embodiment of the present invention, in order to generate the BHS data associated with the customer, the BHS module 112 may first sanitize the customer interaction data by filtering out unwanted text, correcting misspelled words, converting abbreviations to proper text and by replacing domain specific terms to expanded terms in the customer interaction data. The BHS module 112 may then categorize the sanitized customer interaction data into predefined categories to generate the BHS data associated with the customer. In an embodiment of the present invention, the BHS module 112 may generate the BHS data associated with each delinquent customer of the financial institution. The generated BHS data is then stored by the BHS module 112 along with domain specific rules and heuristic. In embodiments of the present invention, the domain may be mortgage loans and the domain specific rule may comprise considering a customer to be delinquent when the call center executive has logged notes for more than two months while interacting with the customer for the loan recovery. The domain specific rule may also comprise grouping all the notes, for processing, that are logged in a month for a delinquent customer. According to the domain heuristics when no notes have been logged for a customer the gap may be interpreted as one of the three following categories Paid (PD), Not Paid (NP), and Not-Available (NA). The category ‘PD’ corresponds that the customer has paid the loan amount or the loan installments. The category ‘NP’ corresponds that the customer has not paid the loan amount or the loan installments. The category ‘NA’ corresponds that the customer was not available when the executive of the call center tried reaching the customer for loan recovery. The customer may further be treated as ‘NA’ when the comments corresponding to the customer are missing for a month. In an embodiment of the present invention, according to the domain heuristics the extreme ends of the BHS data may be converted as ‘NA’ for processing the customer interaction data corresponding to the customer.

The stored BHS data from the BHS module 112 is received by the prediction module 114. In various embodiments of the present invention, the prediction module 114 may be hardware or software or hardware with embedded software or a firmware that is configured to predict the loan recovery decision pertaining to the customer. In an embodiment of the present invention, the predicted loan recovery decision is based on predicted payment behavior of the customer. In an embodiment of the present invention, the prediction module 114 may utilize the BHS data associated with the customer from the BHS module 112, the customer profile data from the second database 104, and the economic data from the third database 106 to predict the loan recovery decision pertaining to the customer. Further, the predicted loan recovery decision is stored in fourth database 110. In various embodiments of the present invention, the fourth database 110 may be hardware or software or hardware with embedded software or a firmware for storing the predicted loan recovery decision. The fourth database 110 may be a memory or a storage device operable to store the predicted loan recovery decision. For example, the fourth database 110 is a RAM, a ROM, an optical storage device, a magnetic media, etc., either integrated with the system 100 or configured as a separate device. The predicted loan recovery decision may be stored in the fourth database 110 in a relational manner, in a flat file manner or any other known manner in the art. In an embodiment of the present invention, the fourth database 110 may store the predicted loan recovery decisions pertaining to all the delinquent customers of the financial institution. Further in an embodiment of the present invention, the computer system may display the predicted loan recovery decision on the display unit in the form of, without any limitation, a list of customers who are likely to default and their associated loan recovery decisions, a pie chart showing the percentage of the customers who are defaulters, cooperative in repaying the loan and in ‘Not Available’ states and their associated loan recovery decisions, a plot of geographically distributed customers with payment behavior states and their associated loan recovery decisions. In another embodiment of the present invention, the computer system may transmit the predicted loan recovery decisions as syndicated data streams to other computer systems over the communication network. In various embodiments of the present invention, the communication network may be, without any limitation, LAN, MAN, WAN like Internet, and private network.

Hereinafter, the present invention is detailed with respect to the call center notes (interchangeably referred to as ‘call center comments’ or ‘comments’) as the customer interaction data. It would be appreciated by a person of ordinary skill in the art that the present invention is equally well suited to other types of the customer interaction data without any limitation. Further, the present invention is described herein in the context of the collateral-based or the mortgage loans. The present invention, however, may be utilized in many different contexts for other types of debt collections. Therefore, one skilled in the art will recognize that the present invention is not limited to practice with the collateral-based loans or the mortgage loans.

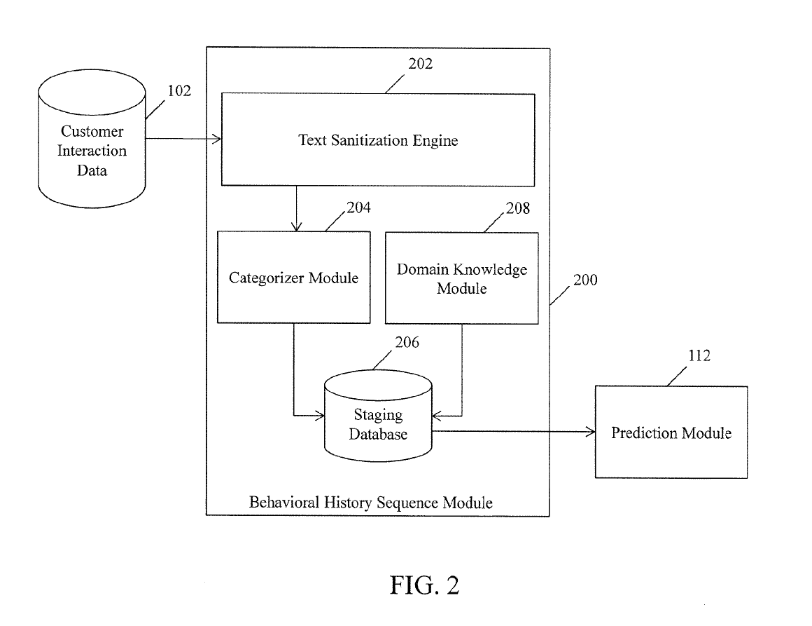

FIG. 2 is a block diagram illustrating architecture of a BHS module 200 in accordance with an embodiment of the present invention. In embodiments of the present invention, the BHS module 200 may be hardware or software or hardware with embedded software or a firmware that is configured to generate the BHS data associated with the customer. In an embodiment of the present invention, the BHS module 200 generates BHS data associated with all the delinquent customers of the financial institution. The BHS module 200 includes a text sanitization engine 202, a categorizer module 204, a staging database 206, and a domain knowledge module 208. In embodiments of the present invention, the text sanitization engine 202 may be hardware or software or hardware with embedded software or a firmware that is configured to filter out unwanted text from call center notes and correct spellings in the call center notes. The text sanitization engine 202 may receive the call center notes from the first database 102 and may filter out the unwanted text from the call center notes using known in the art text filtering techniques. In various embodiments of the present invention, the filtering may include, without any limitation, removing specials characters, formatting punctuations, and removing white space characters. In an embodiment of the present invention, the filtered call center notes are indexed and are further processed to correct the spellings in the call center notes. In an embodiment of the present invention, the text sanitization engine 202 may correct the spellings in the filtered call center notes by applying an algorithm that may use a Domain Specific Acronym List (DSA), a Domain Dictionary (DD), an English Language Dictionary (ED) and threshold parameters. The DSA may contain domain related acronyms list like PFP (Promise for Payment). In an exemplary embodiment of the present invention, the domain may be a financial domain which deals with the mortgage loans. The DD may comprise a list of words that is prepared after processing large number of call center notes. In an exemplary embodiment of the present invention, the misspelled word ‘browr’ may be ‘Borrower’ and not the ‘Browser’ according to DD. In an embodiment of the present invention, the algorithm begins with searching for every token in a comment in the ED. In an exemplary embodiment of the present invention, a tree based optimal search algorithm is used to search the token in the ED. In case, the token is found in the ED, the token is retained in the comment. Else, the algorithm treats the token as a misspelled word. Next, the token is checked against the DSA. In an embodiment of the present invention, the DSA may initially contain a list of acronyms like ‘PFP’ (Promise for Payment). In case, no correction exists upon checking the token against the DSA, the algorithm proceeds to the next step which is construction of positional patterns with a priority. In an exemplary embodiment of the present invention, the positional patterns constructed from a misspelled token ‘cust’ and their priority levels may be as depicted in TABLE 1.

TABLE 1

| Positional Pattern | Priority Level |
|---|---|
| cust | 1 |
| cust.* | 2 |
| cus.*t | 3 |
| cus.*t.* | 4 |
| cu.*s.*t | 5 |
| c.*u.*s.*t | 6 |
| c.*u.*s.*t.* | 7 |

After the positional patterns and their priority levels have been constructed, the algorithm then matches every relevant word in the DD against the patterns in order of their priority. The relevant word begins with the same alphabets as that of the token. Further, a correction that conforms to a pattern at a particular priority level is found the remaining patterns are ignored. In an embodiment of the present invention, when multiple words from the DD match a pattern at the same priority level, the word that has least Levenshtein distance from the token is chosen as the correction. The Levenshtein distance is a measure of the similarity between two strings, which may be referred to as the source string and the target string. The distance is the number of deletions, insertions, or substitutions required to transform source string into target string. Further, in case a valid correction is found, checks are done to affirm the accuracy of the correction. A check may comprise checking if the token is a prefix of a correction. In case the token is a prefix, the correction is considered to be a valid correction. Otherwise, a check based on the Consonant Density Ratio (CDR) is performed. The CDR is defined as: CDR(word1,word2)=No. of consonants in word₁/No. of consonants in word₂. When CDR(token, correction) is greater than a predefined threshold value, the correction is validated and no further checks are performed. When the CDR(token, correction) is less than or equal to the predefined threshold value, a stemmed version (correctionₛₜₑₘ) of the correction is computed. In an embodiment of the present invention when the CDRₛₜₑₘ is less than or equal to the predetermined threshold value, the correction is considered to be invalid and a Relevant Anagram of the token is searched in the DD and is returned as the correction if the relevant Anagram exists. In another embodiment of the present invention, when the CDR(tokenₛₜₑₘ, correctionₛₜₑₘ) is greater than the predetermined threshold value, the algorithm checks if the consonant character sets are same for both token and the correction. When the consonant character sets are different, the correction is considered to be invalid and a relevant anagram of the token is searched in the DD and is returned as the correction if the relevant anagram exists. Further, the token is retained in the comment. In an embodiment of the present invention, when no correction is found by the algorithm at the end of the above mentioned steps, the word in the DD that has the same character set as that of the token and for which the Levenshtein distance is minimum, is chosen as a correction. Further, when the algorithm successfully finds a correction that passes the different validation checks, all occurrences of the token in the comment are replaced by the correction. The token is also added as an acronym, with the correction as its expansion, in the DSA. After the spellings in the comments have been sanitized, the sanitized comments are received by the categorizer module 204.

In various embodiments of the present invention, the categorizer module 204 is hardware or hardware with embedded software or a firmware that is configured to classify the sanitized comments into predefined categories to form the BHS data associated with the customer. In an embodiment of the present invention, the categorizer module 204 categorizes the sanitized comments for all the delinquent customers of the financial institution. The predefined categories may correspond to payment behavioral states of the customer and may be, without any limitation, ‘Promise to Pay’, ‘Negotiation Fail’, and ‘NA’. The predefined category ‘Promise to Pay’ may correspond that the customer has promised to pay the loan amount or the loan installments. The predefined category ‘Negotiation Fail’ may correspond that the negotiations for recovering the loan amount or the loan installment from the customer has been failed. The predefined category ‘NA’ may correspond that the customer was not available when the executive of the call center tried reaching the customer for recovering the loan amount or the loan installments. Further, each of the predefined categories may have a set of keywords with attached weights. The keywords may be unigram, bigram or trigram words. In an embodiment of the present invention, global weights may also be assigned for the unigrams, trigrams and bigrams keywords. In an embodiment of the present invention, the categorizer module 204 may use naive Bayes classification algorithm to classify the comments. The naive Bayes classification algorithm may assign separate probabilities to the comments that belong to each of the different categories based on keyword hits, their frequencies and weights. A comment may be classified into the category with the highest probability. The comments may also get classified in multiple categories. The comments for the customer may be classified against the unique identification code assigned to the customer. Further in an exemplary embodiment of the present invention, the categorizer module 204 may receive the comments logged over a period of forty eight months for classification. The categorizer module 204 may classify these comments of a month into one of the predefined categories and repeat the process for all the subsequent months, thus forming BHS data. In an exemplary embodiment of the present invention, if no comment has been logged for a month for the customer, the corresponding behavioral state is assigned ‘Not-Available’. Further, the length of the BHS data may be uniform across all the delinquent customers of the financial institution and may be based on the minimum and maximum dates in the timestamps of comments received from the first database 102.

The BHS data associated with the customer from the categorizer module 204 is stored in the staging database 206. In an embodiment of the present invention, the staging database 206 may store the BHS data associated with all the delinquent customers of the financial institution. In various embodiments of the present invention, the staging database 206 may be hardware or software or hardware with embedded software or a firmware for storing the BHS data. The staging database 206 may be a memory or a storage device operable to store the BHS data. For example, the staging database 206 is a RAM, a ROM, an optical storage device, a magnetic media, etc., either integrated with the system 100 or configured as a separate device. The BHS data may be stored in the staging database 206 in a relational manner, in a flat file manner or any other known manner in the art. Further, the staging database 206 may store the BHS data corresponding to the customer along with the unique identification code of the customer, time stamps, and other relevant metadata. The staging database 206 may also store the domain specific rules and the domain heuristic received from the domain knowledge module 208. Also, configuration parameters for all the algorithms applied on the BHS data may also be maintained in the staging database 206. The configuration parameters may include, without any limitation, selection of time duration to process the call center notes. The BHS data from the staging database 206 is then received by the prediction module 114 to generate predictions of the payment behavior of the customer and the associated loan recovery decision pertaining to the customer based on the payment behavior of the customer.

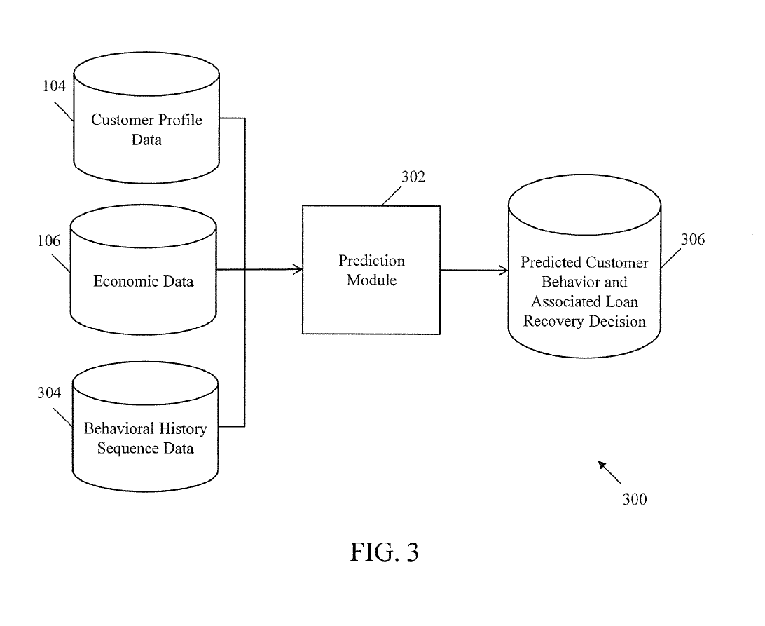

FIG. 3 is a block diagram of a system 300 for predicting payment behavior of the customer and the associated loan recovery decision pertaining to the customer in accordance with an embodiment of the present invention. The system 300 comprises a prediction module 302 communicatively coupled to the second database 104, the third database 106, a fifth database 304 comprising BHS data, and a sixth database 306 comprising predicted customer behavior and associated loan recovery decision. In an embodiment of the present invention, the fifth database 304 may be similar to the staging database 206 as discussed in conjunction with FIG. 2. Further in various embodiments of the present invention, the prediction module 302 may be hardware or software or hardware with embedded software or a firmware configured to predict the payment behavior of the customer and the associated loan recovery decision. In an embodiment of the present invention, the prediction module 302 may employ a Bayesian network with a plurality of nodes to predict the payment behavior of the customer and the associated loan recovery decision pertaining to the customer. The Bayesian network is a probabilistic graphical model that represents a set of variables and their conditional dependencies. The Bayesian network is expressed as an acyclic-directed graph where a node corresponds to a variable. In various embodiments of the present invention, the variable may be, without any limitation, a measured parameter, a latent variable, and a hypothesis. The edges of the graph represent statistical parent-child relationships among the nodes or variables and local probability distributions for each variable for given values of the parent's variable. Further, in a Bayesian network, a node without parents is called a root node, and a node without children is called a leaf node. The node that is neither a leaf node nor or a root node is called an intermediate node. The root nodes represent the causes, while the leaf nodes represent the final effects. In an embodiment of the present invention, the Bayesian network may be used to perform probabilistic inference. The probabilistic inference may be performed by inputting values of evidence variables, or variables with observed states. After the evidence nodes have been updated with the observed states, the posterior probabilities of the other nodes may be computed. In an embodiment of the present invention, the evidence nodes may correspond to the root nodes and the decisions are made or results are derived based on the posterior probabilities of the leaf nodes. In exemplary embodiments of the present invention, the prediction module 302 may apply probabilistic inference algorithms including, without any limitation, variable elimination, Markov Chain Monte Carlo simulation, clique tree propagation, and recursive conditioning for producing inferences from the Bayesian network.

The Bayesian network may be created by a person known as domain analyst using known in the art techniques including, without any limitation, data based approach, knowledge based approach, and a hybrid approach that uses both the data based approach and the knowledge based approach. In an embodiment of the present invention, the domain analyst uses a data based approach to create the Bayesian network using a user interface provided by the prediction module 302. In various embodiments of the present invention, the user interface may be, without any limitation, a Graphical User Interface (GUI), a machine interface and a remote interface that may provide a user (the domain analyst and/or machine) an access to the Bayesian network. Further, in the data based approach the domain analyst takes help of a domain expert to first determine the variables of the domain. In an exemplary embodiment of the present invention, the domain may be analysis of the mortgage loans. Next, data is accumulated for the determined variables and a Bayesian structural learning algorithm is applied to create an initial Bayesian network from this data. Once the initial Bayesian network is created, the domain expert may evaluate and customize the generated initial Bayesian network based on his domain knowledge to generate a final Bayesian network.

In another embodiment of the present invention, the domain analyst uses the knowledge based approach to create the Bayesian network using the user interface. To use this approach, the domain analyst firstly interviews the domain expert to obtain the knowledge of the domain related to the field of his expertise. Then, the domain analyst and domain expert determine the factors or aspects that are important for decision making in the field of the domain expert. These factors or aspects correspond to the variables or nodes of the Bayesian network. The domain analyst and the domain expert next determine the dependencies among the variables (the arcs) and the probability distributions that quantify the strengths of the dependencies to create an initial Bayesian network. Once the initial Bayesian network is created, the domain expert may evaluate and customize the generated initial Bayesian network based on his domain knowledge to create a final Bayesian network.

In yet another embodiment of the present invention, the domain analyst uses both the data based approach and the knowledge based approach to create the Bayesian network via user interface. Thus, the nodes or variables of the Bayesian network may correspond to both the accumulated data and the knowledge of the domain expert.

Further, each node of the Bayesian network may be associated with a number of states. The states of the node refer to the possible values of the variable represented by the node. A variable or node may be defined to assume ‘n’ states (where n≧2 and ‘n’ belongs to the set of natural numbers). The number of states of a node, as well as the number of states of each of the parent node, defines a conditional probability table (CPT) associated with the variable in Bayesian network. In an embodiment of the present invention, each node is defined to assume at least two states, True and False (Boolean format). In this scheme, if a node has ‘x’ number of parent nodes, the associated CPT has 2^{x} dimensions, i.e., 2^{x} probability values need to be populated in the CPT. It will be apparent to a person of ordinary skill in the art that any probability distribution format is applicable to various embodiments of the present invention, and the states of each node in the Bayesian networks is assumed to be in a Boolean format, only for exemplary purposes. Further the states of the nodes in a Bayesian network may be defined by the domain expert based on the nature of variables and how much discrete states are required for a node. In an example a node ‘Interest Rate’ may be defined into three discrete states ‘Low’, ‘Medium’, and ‘High’ where the state ‘Low’ corresponds to low interest rate, the state ‘Medium’ corresponds to medium interest rate and the state ‘High’ corresponds to high interest rate. The states of the nodes may also represent different discrete choices of the domain expert. In an embodiment of the present invention, when a node represents different types of payment behaviors of a delinquent customer the states of the node may correspond to all possible payment behaviors of the delinquent customer like, without any limitation, ‘Likely to Pay’, ‘Defaulter’, and ‘Negotiable’. Similarly, for predicted loan recovery decisions pertaining to the delinquent customer based on his payment behaviors the states may correspond to, without any limitation, ‘Strict Follow-up’ and ‘Lenient Follow-up’.

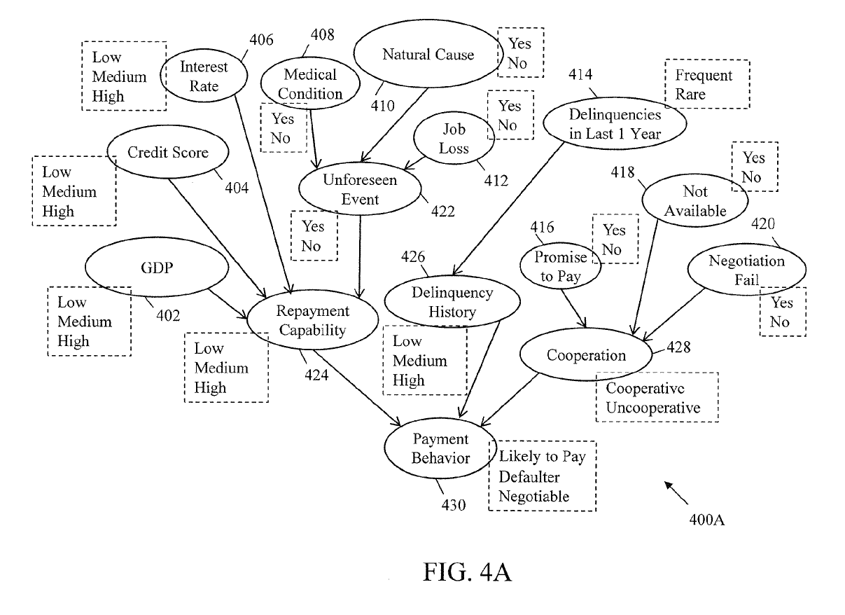

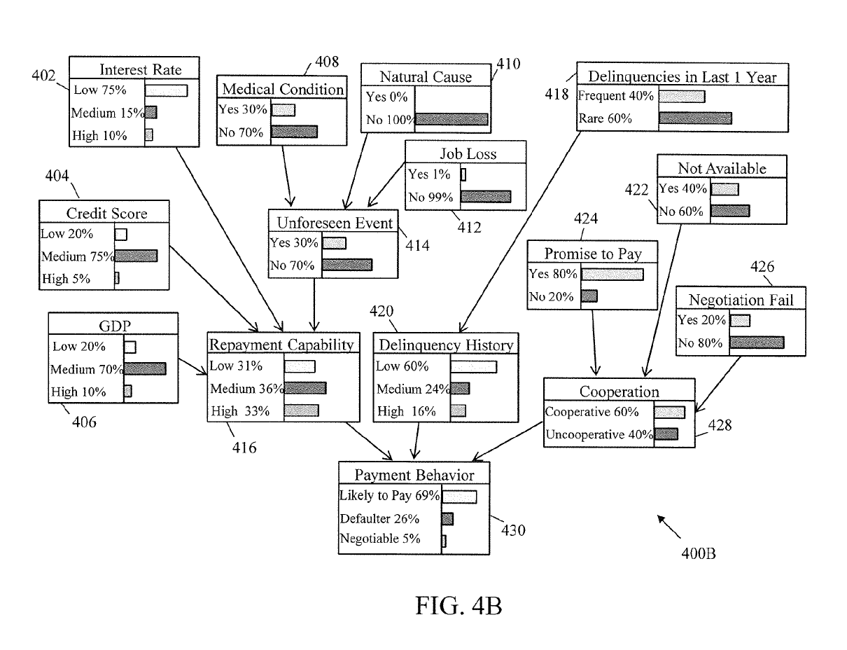

FIGS. 4A and 4B illustrate exemplary Bayesian networks 400A and 400B to predict the payment behavior of the customer in accordance with an embodiment of the present invention. The examples shown in FIGS. 4A and 4B are not intended to limit the scope of the present invention. In an embodiment of the present invention, the customer is a delinquent customer of the financial institution. In an embodiment of the present invention, the exemplary Bayesian networks 400A and 400B may be utilized to predict the payment behavior of each delinquent customer of the financial institution. In an embodiment of the present invention, the Bayesian network 400A may be created by the domain analyst using the data based approach. As depicted in FIG. 4A, the Bayesian network 400A comprises a plurality of nodes including ‘GDP’ 402, ‘Credit Score’ 404, ‘Interest Rate’ 406, ‘Medical Condition’ 408, ‘Natural Cause’ 410, ‘Job Loss’ 412, ‘Delinquencies in last 1 year’ 414, ‘Promise to Pay’ 416, ‘Not Available’ 418, ‘Negotiation Fail’ 420, ‘Unforeseen Event’ 422, ‘Repayment Capability’ 424, ‘Delinquency History’ 426, ‘Cooperation’ 428, and ‘Payment Behavior’ 430. Further, each node of the plurality of the nodes is associated with two or more states.

In an embodiment of the present invention, the node ‘GDP’ 402 is a root node that corresponds to the GDP within the customer's country. The data for the node ‘GDP’ 402 may be accumulated from the economic data stored in the third database 106. Further, the node ‘GDP’ 402 may have three states ‘Low’, ‘Medium’, and ‘High’, where the state ‘low’ may correspond to a low GDP, the state ‘Medium’ may correspond to a medium GDP, and the state ‘High’ may correspond to a high GDP.

In an embodiment of the present invention, the node ‘Credit Score’ 404 is a root node that may correspond to the creditworthiness of the customer. The data for the node ‘Credit Score’ 404 may be accumulated from the customer profile data stored in the second database 104. Further, the node ‘Credit Score’ 404 may have three states ‘Low’, ‘Medium’, and ‘High’, where the state ‘Low’ may correspond to a low credit score, the state ‘Medium’ may correspond to a medium credit score, and the state ‘High’ may correspond to a high credit score of the customer.

In an embodiment of the present invention, the node ‘Interest Rate’ 406 is a root node that may correspond to the rate which is charged to or paid by the customer for the loan given by the financial institution. The data for the node ‘Interest Rate’ 406 may be accumulated from the economic data stored in the third database 106. Further, the node ‘Interest Rate’ 406 may have three states ‘Low’, ‘Medium’ and ‘High’, where the state ‘Low’ may correspond to a low interest rate, the state ‘Medium’ may correspond to a medium interest rate, and the state ‘High’ may correspond to a high interest rate.

In an embodiment of the present invention, the node ‘Medical Condition’ 408 is a root node that may correspond to presence of any kind medical condition of the customer that may influence the payment behavior of the customer. The data for the node ‘Medical Condition’ 408 may be accumulated from the customer profile data stored in the second database 104. Further, the node ‘Medical Condition’ 408 may have two states ‘Yes’ and ‘No’, where the state ‘Yes’ may correspond to the presence of the medical condition, and the state ‘No’ may correspond to the absence of the medical condition.

In an embodiment of the present invention, the node ‘Natural Cause’ 410 is a root node that may correspond to presence of any kind of natural calamity associated with the customer that may influence the payment behavior of the customer. The data for the node ‘Natural Cause’ 410 may be accumulated from the customer profile data stored in the second database 104. Further, the node ‘Natural Cause’ 410 may have two states ‘Yes’ and ‘No’, where the state ‘Yes’ may correspond to presence of the natural calamity, and the state ‘No’ may correspond to an absence of the natural calamity.

In an embodiment of the present invention, the node ‘Job Loss’ 412 is a root node that may correspond to the loss of employment of the customer. The data for the node ‘Job Loss’ 412 may be accumulated from the customer profile data stored in the second database 104. Further, the node ‘Job Loss’ 412 may have two states ‘Yes’ and ‘No’, where the state ‘Yes’ may correspond that the customer may have lost his employment and the state ‘No’ may correspond that the customer may not have lost his employment.

In an embodiment of the present invention, the node ‘Delinquencies in last 1 year’ 414 is a root node that may correspond to the frequency of the delinquencies of the customer in a period of one year. The data for the node ‘Delinquencies in last 1 year’ 414 may be accumulated from the customer profile data stored in the second database 104. Further, the node ‘Delinquencies in last 1 year’ 414 may have two states ‘Frequent’ and ‘Rare’, where the state ‘Frequent’ may correspond that the customer was frequently delinquent, the state ‘Rare’ may correspond that the customer was rarely delinquent.

In an embodiment of the present invention, the node ‘Promise to Pay’ 416 is a root node that may correspond whether the customer has committed or not for repaying the loan to the financial institution when the executive of the call center interacted with the customer for recovering the loan amount or the loan installments. The data for the node ‘Promise to Pay’ 416 may be accumulated from the BHS data associated with the customer. Further, the node ‘Promise to Pay’ 416 may have two states ‘Yes’ and ‘No’, where the state ‘Yes’ may correspond that the customer may have committed repaying the loan and the state ‘No’ may correspond that the customer may not have committed repaying the loan.

In an embodiment of the present invention, the node ‘Not Available’ 418 is a root node that may correspond whether the customer was available or not when the executive of the call center tried reaching the customer for recovering the loan amount or the loan installments. The data for the node ‘Not Available’ 418 may be accumulated from the BHS data associated with the customer. The node ‘Not Available’ 418 may have two states ‘Yes’ and ‘No’, where the sate ‘Yes’ may correspond that customer was not available and the state ‘No’ may correspond that the customer was available.

In an embodiment of the present invention, the node ‘Negotiation Fail’ 420 is root node that may correspond whether the negotiation of the executive of the call center with the customer regarding the loan recovery failed or not. The data for the node ‘Negotiation Fail’ 420 may be accumulated from the BHS data associated with the customer. Further, the node ‘Negotiation Fail’ 420 may have two states ‘Yes’ and ‘No’, where the state ‘Yes’ may correspond that the negotiation failed and the state ‘No’ may correspond that the negotiation did not fail.

In an embodiment of the present invention, the node ‘Unforeseen Event’ 422 is an intermediate node and is dependent on the outcomes of the nodes ‘Medical Condition’ 408, ‘Natural Cause’ 410, and ‘Job Loss’ 412. The node ‘Unforeseen Event’ 422 may have two states ‘Yes and ‘No’, where the states ‘Yes’ may correspond to presence of an unforeseen event associated with the customer that may influence the payment behavior of the customer. The state ‘No’ may correspond to an absence of an unforeseen event. In an embodiment of the present invention, the probabilities of the two states of the node ‘Unforeseen Event’ 422 may be computed by the prediction module 302 on the basis of the conditional probabilities of the states of the nodes ‘Medical Condition’ 408, ‘Natural Cause’ 410, and ‘Job Loss’ 412.

In an embodiment of the present invention, the node ‘Repayment Capability’ 424 is an intermediate node and is dependent on the nodes ‘Unforeseen Event’ 422, ‘GDP’ 402, ‘Credit Score’ 404, ‘Interest Rate’ 406. The node ‘Repayment Capability’ 424 may correspond to capability of the customer in repaying the loan amount to the financial institution. Further, the node ‘Repayment Capability’ 424 may have three states ‘Low’, ‘Medium’, and ‘High’, where the state ‘Low’ may correspond to a low repayment capability, the state medium may correspond to a medium repayment capability and the state ‘High’ may correspond to a high repayment capability of the customer. In an embodiment of the present invention, the probabilities of the three states of the node ‘Repayment Capability’ 424 may be computed by the prediction module 302 on the basis of the conditional probabilities of the states of the nodes Unforeseen Event’ 422, ‘GDP’ 402, ‘Credit Score’ 404, ‘Interest Rate’ 406.

In an embodiment of the present invention, the node ‘Delinquency History’ 426 is an intermediate node and is dependent on the node ‘Delinquencies in last 1 year’ 414. The node ‘Delinquency History’ 426 may correspond to an overall history of the customer of being delinquent. Further, the node ‘Delinquency History’ 426 may have three states ‘Low’, ‘Medium’, and ‘High’, where the state ‘Low’ may correspond to lower delinquency by the customer in the past, the state ‘Medium’ may correspond to a medium delinquency, and the state ‘High’ may correspond to a higher delinquency by the customer in the past. In an embodiment of the present invention, the probabilities of the three states of the node ‘Delinquency History’ 426 may be computed by the prediction module 302 on the basis of the conditional probabilities of the states of the node ‘Delinquencies in last 1 year’ 414.

In an embodiment of the present invention, the node ‘Cooperation’ 428 is an intermediate node and is dependent on the nodes ‘Promise to Pay’ 416, ‘Not Available’ 418, and ‘Negotiation Fail’ 420. The node ‘Cooperation’ 428 may correspond whether the customer is cooperative or not when the executive of the call center interacts with the customer for recovering the loan. Further, the node ‘Cooperation’ 428 may have two states ‘Cooperative’ and ‘Uncooperative’, where the state ‘Cooperative’ may correspond to cooperative attitude of the customer in repaying the loan and the state ‘Uncooperative’ may correspond to uncooperative attitude of the customer in repaying the loan. In an embodiment of the present invention, the probabilities of the two states of the node ‘Cooperation’ 428 may be computed by the prediction module 302 on the basis of the conditional probabilities of the states of the nodes ‘Promise to Pay’ 416, ‘Not Available’ 418, and ‘Negotiation Fail’ 420.

In an embodiment of the present invention, the node ‘Payment Behavior’ 430 is a leaf node and is dependent on the nodes ‘Repayment Capability’ 424, ‘Delinquency History’ 426, and ‘Cooperation’ 428. The node ‘Payment Behavior’ 430 may correspond to the payment behavior of the customer. In an embodiment of the present invention, the customer may be a delinquent customer of the financial institution and the states of the node ‘Payment Behavior’ 430 may correspond to the payment behaviors of the customer. The node ‘Payment Behavior’ 430 may have three states ‘Likely to Pay’, ‘Defaulter’, and ‘Negotiable’, where the state ‘Likely to Pay’ may correspond that the customer is likely to pay the loan amount or the loan installments to the financial institution, the state ‘Defaulter’ may correspond that the customer is going to be a defaulter with regards to the repayment of the loan amount or the loan installments, and the state ‘Negotiable’ may correspond that the customer is negotiable with regards to the repayment of the loan amount or the loan installments. The probabilities of the three states of the node ‘Payment Behavior’ 430 may be computed by the prediction module 302 on the basis of the probabilities of the states of the nodes ‘Repayment Capability’ 424, ‘Delinquency History’ 426, and ‘Cooperation’ 428.

In an embodiment of the present invention, the prediction module 302 predicts the payment behavior of the customer based on the state of each node of the plurality of nodes of the Bayesian network. In order to predict the states of each node of the Bayesian network 400A, the Bayesian network 400A is converted into a computer-readable form, such as a file and is fed into the prediction module 302. The prediction module 302 then inputs the data into one of the nodes of the Bayesian network 400A. In an embodiment of the present invention, the prediction module 302 inputs the BHS data associated with the customer, from the first database 102, into the nodes ‘Promise to Pay’ 416, ‘Not Available’ 418, and ‘Negotiation Fail’ 420. The customer profile data, from the second database 104, is inputted into the nodes ‘Credit Score’ 404, ‘Medical Condition’ 408, ‘Natural Cause’ 410, ‘Job Loss’ 412, and ‘Delinquencies in last 1 year’ 414. The economic data, from the third database 106, is inputted into the nodes ‘GDP’ 402 and ‘Interest Rate’ 406. In an embodiment of the present invention, based on the BHS data, the customer profile data and the economic data, the prediction module 302 may compute the posterior probabilities of the states of the nodes as depicted in the exemplary Bayesian network 400B. Further, based on the posterior probabilities of the states of the nodes and the CPT within each intermediate node, the prediction module 302 may compute the posterior probabilities of the states of the intermediate nodes ‘Unforeseen Event’ 422, ‘Repayment Capability’ 424, ‘Delinquency History’ 426, and ‘Cooperation’ 428. In an embodiment of the present invention, the exemplary Bayesian network 400B illustrates the posterior probabilities of the states of the intermediate nodes. The prediction module 302 may then transfer the computed posterior probabilities of the states of the intermediate nodes to the leaf node ‘Payment Behavior’ 430 to compute the posterior probabilities of the states of the leaf node ‘Payment Behavior’ 430. In an embodiment of the present invention, the state of the node ‘Payment Behavior’ 430 with highest posterior probability may be treated as the predicted payment behavior of the customer.

In an embodiment of the present invention, as depicted in the exemplary Bayesian network 400B, the posterior probability of the state ‘Likely to Pay’ is 69% and is highest. Thus, the prediction module 302 infers the payment behavior of the customer that the customer is likely to repay the loan amount or the loan installments to the financial institution. In an exemplary embodiment of the present invention, the payment behavior of the customer may be ‘Likely to Pay’, when the states of the nodes ‘Repayment Capability’ 424 is ‘Medium’, ‘Delinquency History’ 426 is ‘Low’, and ‘Cooperation’ 428 is ‘Cooperative’. The state of the node ‘Repayment Capability’ 424 would be ‘Medium’, when the states of the nodes ‘GDP’ 402 is ‘Medium’, ‘Credit Score’ 404 is ‘Medium’, ‘Interest Rate’ 406 is ‘Low’, and ‘Unforeseen Event’ 422 is ‘No’. The state of the node ‘Unforeseen Event’ 422 would be ‘No’, when the states of the nodes ‘Medical Condition’ 408 is ‘No’, ‘Natural Cause’ 410 is ‘No’, and ‘Job Loss’ 412 is ‘No’. The state of the node ‘Delinquency History’ 426 would be ‘Low’, when the state of the node ‘Delinquencies in last 1 year’ 414 is ‘Rare’. The state of the node ‘Cooperation’ 428 would be ‘Cooperative’, when the states of the nodes ‘Promise to Pay’ 416 is ‘Yes’, ‘Not Available’ 418 is ‘No’, and ‘Negotiation Fail’ 420 is ‘No’.

In an embodiment of the present invention, the prediction module 302 may predict the payment behavior of the customer based on predicted next state of at least one node of the plurality of the nodes. In an embodiment of the present invention, the prediction module 302 employs a neural network to predict next state of the one or more nodes. The neural network may predict the next state of a node using time series analysis. The time series analysis takes an existing series of data e.g. xₜ₋ₙ, . . . xₜ₋₂, xₜ₋₁, xₜ and forecasts the xₜ₊₁, xₜ₊₂ . . . data values. In an exemplary embodiment of the present invention, the neural network may predict the next (t+1) state of a node by analyzing the time series of the data associated with that node. In another exemplary embodiment of the present invention, the neural network may predict the next (t+1) state of a node by analyzing the time series of the data associated with two or more associated nodes. The predicted next state of the node may be set as evidence into the Bayesian network by the domain analyst using the user interface. In an embodiment of the present invention, the evidence may be hard evidence where a node is determined to be in one state with 100% probability. In another embodiment of the present invention, the evidence may be soft evidence where probabilities are distributed among the different states of the node. Once the evidence is introduced into the Bayesian network, the CPT(s) of the node(s) associated with the evidence gets updated to reflect the evidence. In an embodiment of the present invention, the evidence may be introduced in the root nodes. The updated conditional probabilities may then be passed to intermediate node(s) and the leaf node(s), where the conditional probabilities of the intermediate node(s) and the leaf node(s) states are updated using the conditional probability tables found in the intermediate node(s) and the leaf node(s). In an embodiment of the present invention, the neural network may be multilayer Back-Propagation Neural Network (BPNN).

In an embodiment of the present invention, the neural network predicts the next state of the node ‘Job Loss’ 412. The neural network analyzes the BHS data associated with the customer to identify that the customer has lost his job because of the shutdown of the organization with which the customer was associated. Based on this indication of the customer's job loss, the neural network predicts the next state of the root node ‘Job Loss’ 412 as ‘Yes’. The predicted next state of the node is then fed as evidence in the Bayesian network 400A and 400B to predict the payment behavior of the customer. Upon setting the evidence, the posterior probabilities of the states of the intermediate nodes changes. In an embodiment of the present invention, the posterior probability of the state ‘Yes’ of the node ‘Unforeseen Event’ 422 increases, the posterior probability of the state ‘Low’ of the node ‘Repayment Capability’ 424 increases. The prediction module 302 finally transfers the computed posterior probabilities of the states of the intermediate nodes to the leaf node ‘Payment Behavior’ 430 to compute the posterior probabilities of the states of leaf node ‘Payment Behavior’ 430. In an embodiment of the present invention, the posterior probability of the state ‘Defaulter’ of the node ‘Payment Behavior’ 430 increases. Thus, the prediction module 302 infers that the customer is likely to turn defaulter and may not repay the loan amount or the loan installments to the financial institution. A person of ordinary skill in the art may appreciate that the prediction of these behaviors of the customer are merely for illustration purposes. Further, it will be apparent to the person of ordinary skill in the art that there may be many other variables or nodes their relationships and states that may be taken into consideration for predicting payment behaviors of the customer.

In an embodiment of the present invention, when the prediction module 302 predicts that the customer may turn out to be a defaulter due to his job loss because of shutdown of the organization with which the customer was associated, the prediction module 302 may extend the probability of the payment behavior ‘Defaulter’ to all the customers that are in the same organization.

In an embodiment of the present invention, the prediction module 302 may facilitate performing root cause analysis of the payment behavior of the customer. In an embodiment of the present invention, the domain analyst may use the Bayesian network 400A and 400B to perform the root cause analysis of the payment behaviors of all the delinquent customers of the financial institution. In an exemplary embodiment of the present invention, the domain analyst is aware of the interest rate trends of the financial institution and the natural calamities associated with the customer. Based on this knowledge, the domain analyst changes the state of the node ‘Interest Rate’ 406 as ‘High’ and state of the node ‘Natural Cause’ 410 as ‘No’ and sets this as evidence in the Bayesian network 400B. With regards to the set evidence, the Bayesian network 400B predicts the payment behavior of the customer as likely to pay. In an exemplary embodiment of the present invention, the domain analyst applies the same evidence for all the delinquent customers of the financial institution to analyze the number of the delinquent customers that are likely to pay the loan amount. In another exemplary embodiment of the present invention, the domain analyst applies the same evidence for all the delinquent customers of the financial institution to analyze the number of the delinquent customers that may turn defaulters. In yet another exemplary embodiment of the present invention, the domain analyst applies the same evidence for all the delinquent customers of the financial institution to analyze the number of the delinquent customers that may be negotiable with regards to repayment of the loan amount.

In an embodiment of the present invention, the prediction module 302 may facilitate performing sensitivity analysis of the payment behavior of the customer. The sensitivity analysis refers to the analysis of the relationship between the system output and the system variables or nodes under a given input condition. As discussed earlier in conjunction with FIGS. 4A and 4B, the payment behavior of the customer may be ‘Likely to Pay’ when the states of the node ‘Repayment Capability’ 424 is ‘Medium’, Unforeseen Event’ 422 is ‘No’, ‘Medical Condition’ 408 is ‘No’, ‘Natural Cause’ 410 is ‘No’, and ‘Job Loss’ 412 is ‘No’. The sensitivity analysis may be performed by the domain analyst by changing the states of the node ‘Job Loss’ 412 as ‘Yes’ and setting the changed state as evidence in the Bayesian network 400A. The prediction module 302 may predict the change in the payment behavior of the customer by computing the posterior probabilities of the states of the node ‘Payment Behavior’ 430 in response to the change in the state of the node ‘Job Loss’ 412. In an embodiment of the present invention, the prediction module 302 predicts the change in state of the node ‘Unforeseen Event’ 422 as ‘Yes’ and thus the payment behavior of the customer as ‘Defaulter’ when the state of the node ‘Job Loss’ 412 is ‘Yes’. A change in the payment behavior of the customer due to change in the states of the node ‘Job Loss’ 412 indicates that the inference from the exemplary Bayesian networks 400A and 400B are sensitive to the states of the node ‘Job Loss’ 412.

In an embodiment of the present invention, the prediction module 302 may facilitate performing variability analysis of the payment behavior of the customer. The variability analysis refers to the analysis of the relationship between the system output and the system variables or nodes by including or excluding the nodes or variables. As discussed earlier in conjunction with FIGS. 4A and 4B, and the sensitivity analysis, the payment behavior of the customer may be ‘Likely to Pay’ when the state of the node ‘Job Loss’ 412 is ‘No’ and ‘Defaulter’ when the state of the node ‘Job Loss’ 412 is ‘Yes’ with the states of the nodes ‘Medical Condition’ 408 and ‘Natural Cause’ 410 same in both the cases. In an embodiment of the present invention, the variability analysis may be performed by excluding and including the node ‘Job Loss’ 412 from the exemplary Bayesian networks 400A and 400B. The output of the variability analysis may indicate that the inferences from the exemplary Bayesian networks 400A and 400B may vary with addition and deletion of the node ‘Job Loss’ 412.

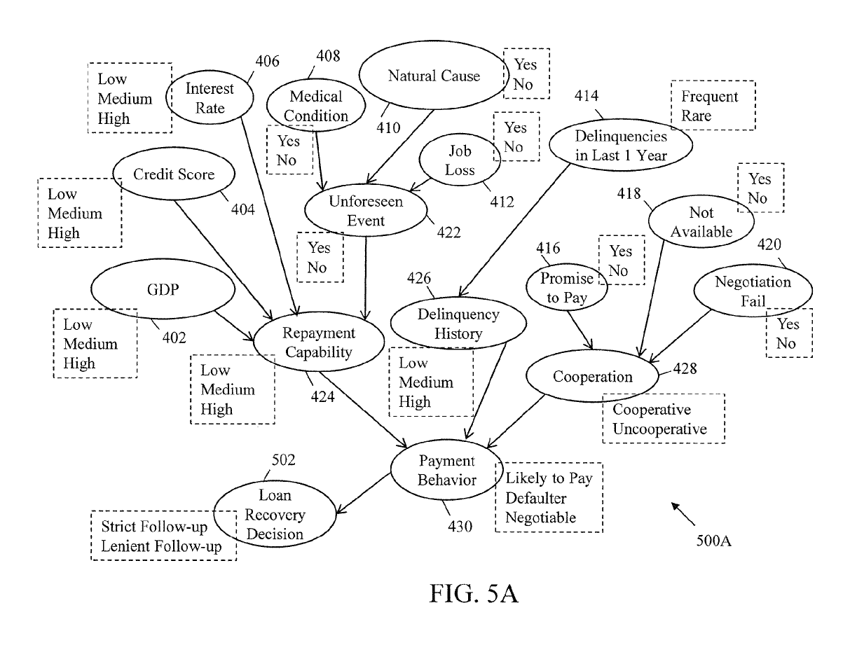

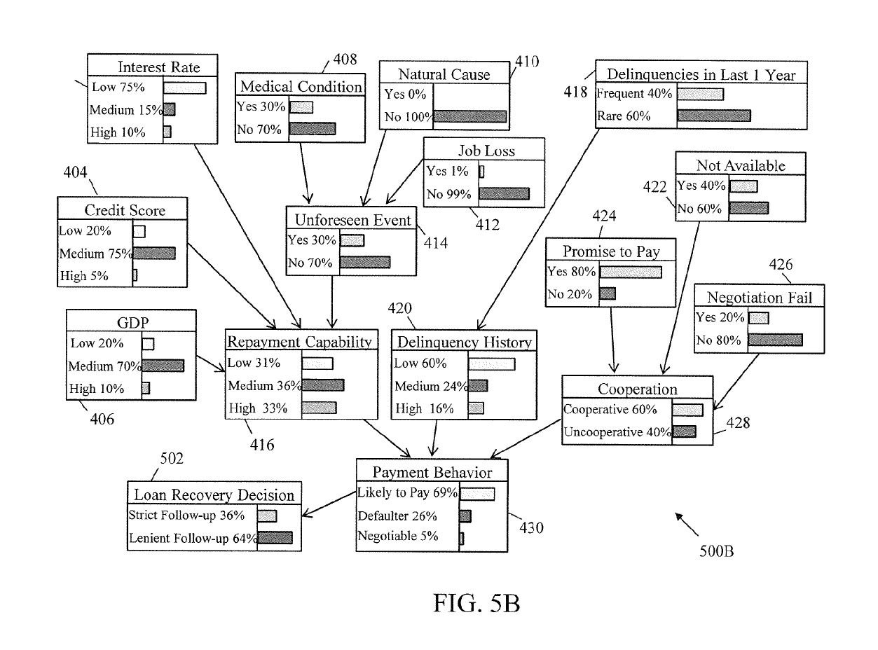

FIGS. 5A and 5B illustrate exemplary Bayesian networks 500A and 500B to predict the loan recovery decision pertaining to the customer in accordance with an embodiment of the present invention. The examples shown in FIGS. 5A and 5B are not intended to limit the scope of the present invention. In an embodiment of the present invention, the exemplary Bayesian network 500A may be utilized to predict loan recovery decisions pertaining to all the delinquent customers of the financial institution. The Bayesian network 500A may be created by the domain analyst using the data based approach. As depicted in FIG. 5A, the Bayesian network 500A comprises a plurality of nodes including ‘GDP’ 502, ‘Credit Score’ 504, ‘Interest Rate’ 506, ‘Medical Condition’ 508, ‘Natural Cause’ 510, ‘Job Loss’ 512, ‘Delinquencies in last 1 year’ 514, ‘Promise to Pay’ 516, ‘Not Available’ 518, ‘Negotiation Fail’ 520, ‘Unforeseen Event’ 522, ‘Repayment Capability’ 524, ‘Delinquency History’ 526, ‘Cooperation’ 528, ‘Payment Behavior’ 530, and ‘Loan Recovery Decision’ 532. The details of the nodes 502-528 and their states as illustrated in FIG. 5A may be similar to that of the details of the nodes 402-428 and their states as illustrated and explained in conjunction with FIG. 4A. The node ‘Payment Behavior’ 530 is an intermediate node and is dependent on the nodes ‘Repayment Capability’ 524, ‘Delinquency History’ 526, and ‘Cooperation’ 528. The details of the node ‘Payment Behavior’ 530 and its states as depicted in FIG. 5A may be similar to that of the details of the node ‘Payment Behavior’ 430 and its states as illustrated and explained in conjunction with FIG. 4A.

In an embodiment of the present invention, the node ‘Loan Recovery Decision’ 532 is a leaf node and is dependent on the node ‘Payment Behavior’ 530. The node ‘Loan Recovery Decision’ 532 may correspond to the loan recovery decisions pertaining to the customer based on the payment behavior of the customer. Further, the node ‘Loan Recovery Decision’ 532 may have two states ‘Strict Follow-up’ and ‘Lenient Follow-up’, where the state ‘Strict Follow-up’ corresponds that a strict follow-up is to be done with the customer to recover the loan and the state ‘Lenient Follow-up’ corresponds that a lenient follow-up is to be done with the customer to recover the loan. In an embodiment of the present invention, the loan recovery decision is based on state of each node of the plurality of the nodes of the Bayesian network 500A.

Referring back to FIG. 3, in an embodiment of the present invention, the prediction module 302 may predict the loan recovery decision pertaining to the customer based on the predicted payment behavior of the customer. In other words, the prediction module 302 may predict the loan recovery decisions pertaining to the customer based on the posterior probabilities of the states of the intermediate node ‘Payment Behavior’ 530. The computation of the posterior probabilities of the states of the intermediate node ‘Payment Behavior’ 530 may be similar to as explained in conjunction with node ‘Payment Behavior’ 430 in FIGS. 4A and 4B. Thereafter, the prediction module 302 may transfer the computed posterior probabilities of the states of the intermediate node ‘Payment Behavior’ 530 to the leaf node ‘Loan Recovery Decision 532 to compute the posterior probabilities of the states of the leaf node ‘Loan Recovery Decision’ 532. In an embodiment of the present invention, the state of the node ‘Loan Recovery Decision’ 532 with highest posterior probability may be treated as the predicted loan recovery decision pertaining to the customer. In an embodiment of the present invention, as depicted in the exemplary Bayesian network 500B, the posterior probability of the state ‘Lenient Follow-up’ is 64% and is more than the posterior probability of the state ‘Strict Follow-up’. Thus, the predicted loan recovery decision pertaining to the customer may be inferred as a lenient follow-up with the customer to recover the loan amount or the loan installments. In another embodiment of the present invention, the predicted loan recovery decision pertaining to the customer may be lenient follow-up when the predicted payment behavior of the customer is negotiable. In yet another embodiment of the present invention, the predicted loan recovery decision pertaining to the customer may be strict follow-up with the customer when the predicted payment behavior of the customer is defaulter.

In an embodiment of the present invention, the prediction module 302 predicts the loan recovery decision pertaining to the customer based on predicted next state of at least one node of the plurality of nodes of the Bayesian network 500A. The neural network predicts the next state of the root node ‘Job Loss’ 512 as ‘Yes’. In such a case, the posterior probabilities of the states of the intermediate nodes changes. In an embodiment of the present invention, the posterior probability of the state ‘Yes’ of the node ‘Unforeseen Event’ 522 increases, the posterior probability of the state ‘Low’ of the node ‘Repayment Capability’ 524 increases. The prediction module 302 finally transfers the computed posterior probabilities of the states of the intermediate nodes to the intermediate node ‘Payment Behavior’ 530 to compute the posterior probabilities of the states of intermediate node ‘Payment Behavior’ 530. In an embodiment of the present invention, the posterior probability of the state ‘Defaulter’ of the node ‘Payment Behavior’ 530 increases. Thus, the prediction module 302 infers the payment behavior of the customer that the customer is likely to turn defaulter and may not repay the loan amount or the loan installments to the financial institution due to his job loss. The prediction module 302 then transfers the computed posterior probabilities of the states of the intermediate node ‘Payment Behavior’ 530 to the leaf node ‘Loan Recovery Decision’ 532 to compute the posterior probabilities of the states of the leaf node ‘Loan Recovery Decision’ 532. In an embodiment of the present invention, the predicted loan recovery decision pertaining to the customer may be computed as lenient follow-up when the payment behavior of the customer is defaulter due to his job loss.

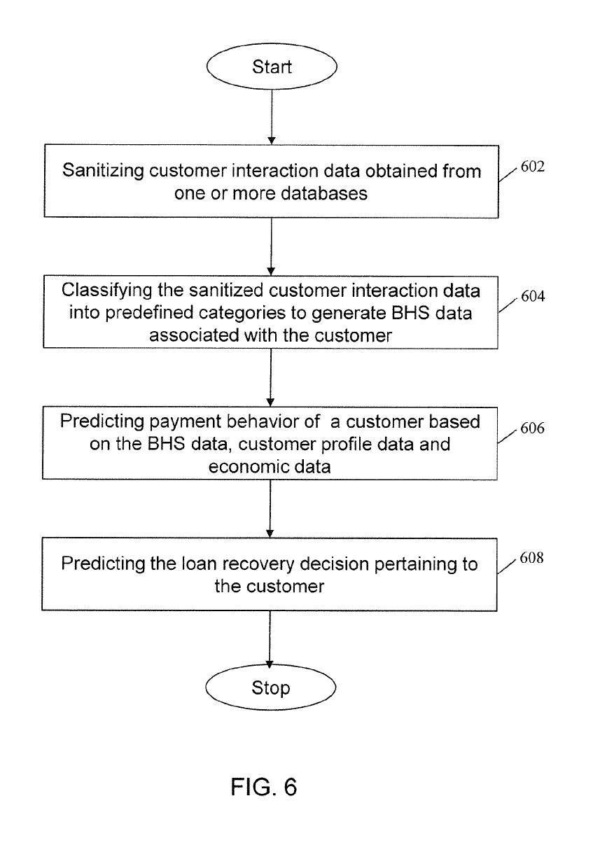

FIG. 6 is a flowchart depicting a method 600 for facilitating prediction of a loan recovery decision pertaining to a customer of a financial institution in accordance with an embodiment of the present invention. At step 602 sanitization of customer interaction data obtained from one or more databases is done. In an embodiment of the present invention, the customer interaction data is unstructured data and comprises, without any limitation, call center notes, text messages from the customer, chats with the customer, emails from the customer, blogs written by the customer, call transcripts associated with the customer, feedback forms filled by the customer, and surveys filled by the customer. Further, the step of sanitization of customer interaction data comprises filtering out unwanted text from the customer interaction data and correcting spellings in the customer interaction data. In an embodiment of the present invention, the spellings in the customer interaction data are corrected using a Domain Specific Acronym (DSA) list, a Domain Dictionary (DD), and an English language dictionary.

At step 604, the sanitized customer interaction data is classified into predefined categories to generate Behavioral History Sequence (BHS) data associated with the customer. In an embodiment of the present invention, the classification of the customer interaction data is done using naive Bayes classification algorithm. Further, the pre-defined categories correspond to payment behavioral states of the customer. In embodiments of the present invention, the payment behavioral states of the customer may be, without any limitation, ‘Promise to Pay’, ‘Negotiation Fail’, and ‘Not Available’.

At step 606, the payment behavior of the customer is predicted based on the BHS data, customer profile data, and economic data. The customer profile data and the economic data are obtained from the one or more databases. In an embodiment of the present invention, the customer profile data is structured data and comprises, without any limitation, name of the customer, age of the customer, gender of the customer, employment details of the customer, bank account details of the customer, contact details of the customer, details of medical condition of the customer, details of natural calamities associated with the customer, credit score of the customer, and details of delinquencies by the customer in repaying the loan in last one year. In an embodiment of the present invention, the economic data is structured data and comprises, without any limitation, Gross Domestic Product (GDP) data, inflation data, and interest rates of the financial institution. Further, the prediction of the payment behavior of the customer is done by employing a Bayesian network with plurality of nodes. Each node of the plurality of the nodes is associated with two or more states. In an embodiment of the present invention, the payment behavior of the customer and the associated loan recovery decision is based on state of each node of the plurality of the nodes. In another embodiment of the present invention, the payment behavior of the customer and the associated loan recovery decision is based on predicted next state of at least one node of the plurality of the nodes. In an embodiment of the present invention, the prediction of the next state of the at least one node of the plurality of the nodes is done by a neural network. Further, the customer may be a delinquent customer of the financial institution and the predicted payment behavior of the customer may be, without any limitation, likely to pay, negotiable, and defaulter. In various embodiments of the present invention, root cause analysis, sensitivity analysis, and variability analysis may be performed for the predicted payment behavior of the customer.

Finally at step 608, the loan recovery decision pertaining to the customer is predicted using the Bayesian network. The predicted loan recovery decision is based on the predicted payment behavior of the customer. Further, in an embodiment of the present invention, the predicted loan recovery decision may be a strict follow-up with the customer. In another embodiment of the present invention, the predicted loan recovery decision may be a lenient follow-up with the customer.

In an embodiment of the present invention, the method 600 may be implemented in a computer system. The computer system may be similar to as disclosed in conjunction with FIG. 1.

In various embodiments, the present invention may be embodied in a computer program product for facilitating prediction of a loan recovery decision pertaining to a customer of a financial institution. The computer program product comprises a non-transitory computer-readable medium having computer-readable program code stored thereon. Further, the computer-readable program code comprises instructions that when executed by a processor, cause the processor to sanitize the customer interaction data obtained from one or more databases. In an embodiment of the present invention, the customer interaction data is unstructured data and comprises, without any limitation, call center notes, text messages from the customer, chats with the customer, emails from the customer, blogs written by the customer, call transcripts associated with the customer, feedback forms filled by the customer, and surveys filled by the customer. Further, the sanitization of customer interaction data may comprise filtering out unwanted text from the customer interaction data and correcting spellings in the customer interaction data. In an embodiment of the present invention, the spellings in the customer interaction data are corrected using a DSA list, a DD, and an English language dictionary.

The processor further classifies the sanitized customer interaction data into predefined categories to generate BHS data associated with the customer. In an embodiment of the present invention, the classification of the customer interaction data is done using naive Bayes classification algorithm. Further, the pre-defined categories correspond to payment behavioral states of the customer. In various embodiments of the present invention, the payment behavioral states of the customer may include, without any limitation, ‘Promise to Pay’, ‘Negotiation Fail’, and ‘Not Available’.

The processor further predicts payment behavior of the customer on the basis of BHS data, customer profile data, and economic data. The customer profile data and the economic data are obtained from the one or more databases. In an embodiment of the present invention, the customer profile data is structured data and comprises, without any limitation, name of the customer, age of the customer, gender of the customer, employment details of the customer, bank account details of the customer, contact details of the customer, details of medical condition of the customer, details of natural calamities associated with the customer, credit score of the customer, and details of delinquencies by the customer in repaying the loan in last one year. In an embodiment of the present invention, the economic data is structured data and comprises, without any limitation, GDP data, inflation data, and interest rates of the financial institution. Further, the prediction of the payment behavior of the customer is done by employing a Bayesian network with plurality of nodes. Each node of the plurality of the nodes is associated with two or more states. In an embodiment of the present invention, the payment behavior of the customer and the associated loan recovery decision is based on state of each node of the plurality of the nodes. In another embodiment of the present invention, the payment behavior of the customer and the associated loan recovery decision is based on predicted next state of at least one node of the plurality of the nodes. In an embodiment of the present invention, the prediction of the next state of the at least one node of the plurality of the nodes is done by a neural network. Further, the customer may be a delinquent customer of the financial institution and the predicted payment behavior of the customer may be, without any limitation, likely to pay, negotiable, and defaulter. In various embodiments of the present invention, the processor further performs root cause analysis, sensitivity analysis, and variability analysis of the predicted payment behavior of the customer.

The processor further predicts the loan recovery decisions pertaining to the customer using the Bayesian network. The predicted loan recovery decision is based on the predicted payment behavior of the customer. Further, in an embodiment of the present invention, the predicted loan recovery decision may be a strict follow-up with the customer. In another embodiment of the present invention, the predicted loan recovery decision may be a lenient follow-up with the customer.

While the exemplary embodiments of the present invention are described and illustrated herein, it will be appreciated that they are merely illustrative. It will be understood by those skilled in the art that various changes in form and detail may be made therein without departing from or offending the spirit and scope of the present invention.

We claim:

1. A system for facilitating prediction of a loan recovery decision pertaining to a customer of a financial institution, the system comprising:
one or more databases comprising customer interaction data, customer profile data, and economic data;
a Behavioral History Sequence (BHS) module configured to generate behavioral history sequence data associated with the customer, wherein the BHS module comprises:
a text sanitization engine configured to:
filter out unwanted text from the customer interaction data, and
correct spellings in the customer interaction data; and
a categorizer module configured to classify the sanitized customer interaction data into predefined categories to generate the BHS data associated with the customer, wherein the pre-defined categories correspond to payment behavioral states of the customer; and
a prediction module configured to predict payment behavior of the customer based on the BHS data, the customer profile data, and the economic data, the prediction module further configured to predict the loan recovery decision pertaining to the customer, wherein the predicted loan recovery decision is based on the predicted payment behavior of the customer.

2. The system of claim 1, wherein the customer interaction data is unstructured data and comprises at least one of: call center notes, text messages from the customer, chats with the customer, emails from the customer, blogs written by the customer, call transcripts associated with the customer, feedback forms filled by the customer, and surveys filled by the customer.

3. The system of claim 1, wherein the customer profile data is structured data and comprises name of the customer, age of the customer, gender of the customer, employment details of the customer, bank account details of the customer, contact details of the customer, details of medical state of the customer, details of natural calamities associated with the customer, credit score of the customer, and details of delinquencies by the customer in repaying the loan in last one year.

4. The system of claim 1, wherein the economic data is structured data and comprises Gross Domestic Product (GDP) data, inflation data, and interest rates of the financial institution.

5. The system of claim 1, wherein the text sanitization engine uses a Domain Specific Acronym (DSA) list, a Domain Dictionary (DD), and an English language dictionary to correct the spellings in the customer interaction data.

6. The system of claim 1, wherein the categorizer module uses naive Bayes classification algorithm to classify the customer interaction data.

7. The system of claim 1, wherein the payment behavioral states of the customer comprise at least one of: ‘Promise to Pay’, ‘Negotiation Fail’, and ‘Not Available’.

8. The system of claim 1, wherein the BHS module further comprises a staging database, the staging database stores the generated BHS data with domain specific rules and heuristics.

9. The system of claim 1, wherein the prediction module employs a Bayesian network with plurality of nodes to predict the payment behavior of the customer and the loan recovery decision pertaining to the customer, wherein each node of the plurality of the nodes is associated with two or more states.

10. The system of claim 9, wherein the payment behavior of the customer and the loan recovery decision is based on one of: state of each node of the plurality of the nodes and predicted next state of at least one node of the plurality of the nodes.

11. The system of claim 10, wherein the prediction module employs a neural network to predict the next state of the at least one node of the plurality of the nodes.

12. The system of claim 1, wherein the customer is a delinquent customer of the financial institution.

13. The system of claim 1, wherein the predicted payment behavior of the customer is one of: Likely to Pay, Negotiable and Defaulter.

14. The system of claim 1, wherein the prediction module further facilitates performing root cause analysis, sensitivity analysis, and variability analysis of the predicted payment behavior of the customer.

15. The system of claim 1, wherein the predicted loan recovery decision pertaining to the customer is one of: a strict follow-up with the customer and a lenient follow-up with the customer.

16. A method for facilitating prediction of a loan recovery decision pertaining to a customer of a financial institution, the method comprising:
sanitizing customer interaction data obtained from one or more databases, wherein the sanitization comprises:
filtering out unwanted text from the customer interaction data; and
correcting spellings in the customer interaction data;
classifying the sanitized customer interaction data into predefined categories to generate BHS data associated with the customer, wherein the pre-defined categories correspond to payment behavioral states of the customer;
predicting payment behavior of the customer based on the BHS data, customer profile data, and economic data; wherein the customer profile data, and the economic data are obtained from the one or more databases; and
predicting the loan recovery decision pertaining to the customer, wherein the predicted loan recovery decision is based on the predicted payment behavior of the customer.

17. The method of claim 16, wherein the customer interaction data is unstructured data and comprises at least one of: call center notes, text messages from the customer, chats with the customer, emails from the customer, blogs written by the customer, call transcripts associated with the customer, feedback forms filled by the customer, and surveys filled by the customer.

18. The method of claim 16, wherein the payment behavioral states of the customer comprise at least one of: ‘Promise to Pay’, ‘Negotiation Fail’, and ‘Not Available’.

19. The method of claim 16, wherein the customer profile data is structured data and comprises name of the customer, age of the customer, gender of the customer, employment details of the customer, bank account details of the customer, contact details of the customer, details of medical state of the customer, details of natural calamities associated with the customer, credit score of the customer, and details of delinquencies by the customer in repaying the loan in last one year.

20. The method of claim 16, wherein the economic data is structured data and comprises GDP data, inflation data, and interest rates of the financial institution.

21. The method of claim 16, wherein the prediction of the payment behavior of the customer and the loan recovery decision pertaining to the customer is done by employing a Bayesian network with plurality of nodes, further wherein each node of the plurality of the nodes is associated with two or more states.

22. The method of claim 21, wherein the payment behavior of the customer and the loan recovery decision is based on one of: state of each node of the plurality of the nodes and predicted next state of at least one node of the plurality of the nodes.

23. The method of claim 22, wherein the prediction of the next state of the at least one node of the plurality of the nodes is done by a neural network.

24. The method of claim 16, wherein the customer is a delinquent customer of the financial institution.

25. The method of claim 16, wherein the predicted payment behavior of the customer is one of: Likely to Pay, Negotiable and Defaulter.

26. The method of claim 16 further comprises performing root cause analysis, sensitivity analysis, and variability analysis of the predicted payment behavior of the customer.

27. The method of claim 16, wherein the predicted loan recovery decision pertaining to the customer is one of: a strict follow-up with the customer and a lenient follow-up with the customer.

28. A computer program product for facilitating prediction of a loan recovery decision pertaining to a customer of a financial institution is provided, the computer program product comprising:
a non-transitory computer-readable medium having computer-readable program code stored thereon, the computer-readable program code comprising instructions that when executed by a processor, cause the processor to:
sanitize the customer interaction data obtained from one or more databases, wherein the sanitization comprises:
filtering out unwanted text from the customer interaction data; and
correcting spellings in the customer interaction data;
classify the sanitized customer interaction data into predefined categories to generate BHS data associated with the customer, wherein the pre-defined categories correspond to payment behavioral states of the customer;
predict payment behavior of the customer based on the BHS data, customer profile data, and economic data; wherein the customer profile data, and the economic data are obtained from the one or more databases; and
predict the loan recovery decision pertaining to the customer, wherein the predicted loan recovery decision is based on the predicted payment behavior of the customer.
